(19) United States
(12) Patent Application Publication
(10) Pub. No.: US 2015/0245647 A1
(43) Pub. Date: Sep. 3, 2015

(54) DRINKING FORMULATIONS WHICH ARE VEGETABLE BASED AND FRUIT BASED

(71) Applicant: Ezra Hamway, New York, NY (US)

(72) Inventor: Ezra Hamway, New York, NY (US)

(21) Appl. No.: 14/193,299

(22) Filed: Feb. 28, 2014

(51) Int. Cl. A23L 2/04; A23L 2/56

(52) U.S. Cl. CPC A23L 2/04; A23L 2/56; A23V 2002/00

(57) ABSTRACT

The present invention provides novel drinking formulations, including a drinking vegetable formulation having the following ingredients: dried sweet potato puree in the range of 9 to 17 grams per drink; dried carrot juice in the range of 6 to 10 grams per drink; dried pure maple syrup in the range of 5.60 to 9.60 grams per drink; cane sugar in the range of 3.00 to 7.00 grams per drink; and dried natural flavoring in the range of 1.50 to 5.0 grams per drink, plus other ingredients. The invention also provides a drinking fruit formulation having the following ingredients: dried strawberry puree in the range of 10.0 to 21.0 grams per drink; dried pure maple syrup in the range of 8.0 to 9.9 grams per drink; cane sugar in the range of 3.0 to 7.0 grams per drink; and dried natural flavoring in the range of 1.2 to 3.25 grams per drink, plus other ingredients.

### FIELD OF THE INVENTION

The present invention relates to novel drinking formulations, including vegetable based drinks and fruit based drinks, having unique combinations of ingredients to provide natural and optimum nutrition, as well as optimum taste.

### BACKGROUND OF THE INVENTION

Presently existing drinks do not meet the goals of providing optimum nutrition and optimum taste using natural ingredients. The present invention meets this goal since the ingredients provide a unique combination, and the quantities of the ingredients are also a unique combination. The details are set forth below.

### OBJECTS OF THE INVENTION

It is an object of the present invention to provide a unique combination of ingredients and a unique combination of quantities of each ingredient, which provide optimum nutrition and optimum taste, using natural ingredients.

### SUMMARY OF THE INVENTION

The present invention provides a drinking vegetable formulation having the ingredients of:

(a) dried sweet potato puree in the range of 9 to 17 grams per drink;

(b) dried carrot juice in the range of 6 to 10 grams per drink;

(c) dried pure maple syrup in the range of 5.60 to 9.60 grams per drink;

(d) cane sugar in the range of 3.00 to 7.00 grams per drink; and

(e) dried natural flavoring in the range of 1.50 to 5.0 grams per drink, plus other so ingredients.

The present invention also provides a drinking fruit formulation having the ingredients of:

(a) dried strawberry puree in the range of 15.0 to 18.0 grams per drink;

(b) dried pure maple syrup in the range of 8.0 to 9.9 grams per drink;

(c) cane sugar in the range of 3.0 to 7.0 grams per drink;

(d) dried raspberry puree in the range of 3.0 to 6.0 grams per drink;

(e) dried blueberry puree in the range of 3.0 to 5.0 grams per drink; and

(f) dried mixed berry natural flavoring in the range of 1.75 to 2.85 grams per drink, plus other ingredients.

The present invention also provides a drinking fruit formulation having the ingredients of:

(a) dried strawberry puree in the range of 18.0 to 21.0 grams per drink;

(b) dried banana puree in the range of 7.50 to 9.25 grams per drink;

(c) dried pure maple syrup in the range of 8.0 to 9.9 grams per drink;

(d) cane sugar in the range of 3.0 to 7.0 grams per drink; and

(e) dried strawberry banana natural flavoring in the range of 1.0 to 2.25 grams per drink, plus other ingredients.

The present invention also provides a drinking fruit formulation having the ingredients of:

(a) dried blueberry puree in the range of 13.0 to 15.0 grams per drink;

(b) dried strawberry puree in the range of 10.0 to 12.25 grams per drink;

(c) dried pure maple syrup in the range of 8.0 to 9.9 grams per drink;

(d) cane sugar in the range of 4.0 to 6.0 grams per drink; and

(e) dried cherry lemon natural flavoring in the range of 1.5 to 2.5 grams per drink, plus other ingredients.

### DETAILED DESCRIPTION OF THE PREFERRED EMBODIMENT

### First Embodiment

A drinking vegetable formulation having the following ingredients:
a) dried sweet potato puree in the range of 9 to 17 grams per drink;
b) dried carrot juice in the range of 6 to 10 grams per drink;
c) dried pure maple syrup in the range of 5.60 to 9.60 grams per drink;
d) cane sugar in the range of 3.00 to 7.00 grams per drink;
e) dried natural peach mango flavoring in the range of 1.50 to 2.25 grams per drink;
f) dried spinach puree in the range of 0.2 to 0.5 grams per drink;
g) dried spinach juice in the range of 0.2 to 0.5 grams per drink;
h) dried beet juice in the range of 0.5 to 0.8 grams per drink;
i) citric acid in the range of 0.5 to 1.0 gram per drink;
j) dried acerola berry juice in the range of 0.10 to 0.30 grams per drink; and
k) water in the range of 11 to 12 fluid ounces per drink.

### Second Embodiment

A drinking vegetable formulation having the following ingredients:
a) dried sweet potato puree in the range of 9 to 17 grams per drink;
b) dried carrot juice in the range of 6 to 10 grams per drink;
c) dried pure maple syrup in the range of 5.60 to 9.60 grams per drink;
d) cane sugar in the range of 3.00 to 7.00 grams per drink;
e) dried natural chocolate cherry flavoring in the range of 3.75 to 6.25 grams per drink;
f) dried spinach puree in the range of 0.2 to 0.5 grams per drink;
g) dried spinach juice in the range of 0.2 to 0.5 grams per drink;
h) dried beet juice in the range of 0.5 to 0.8 grams per drink;
i) dried acerola berry juice in the range of 0.10 to 0.30 grams per drink;
j) dried kale puree in the range of 0.2 to 0.4 grams per drink;
k) dried kale juice in the range of 0.2 to 0.4 grams per drink; and
l) water in the range of 11 to 12 fluid ounces per drink;

### Third Embodiment

A drinking vegetable formulation having the following ingredients:
a) dried sweet potato puree in the range of 9 to 17 grams per drink;
b) dried carrot juice in the range of 6 to 10 grams per drink;
c) dried pure maple syrup in the range of 5.60 to 9.60 grams per drink;
d) cane sugar in the range of 3.00 to 7.00 grams per drink;
e) dried natural creamy orange flavoring in the range of 2.50 to 3.25 grams per drink;
f) citric acid in the range of 0.5 to 1.0 gram per drink;
g) dried acerola berry juice in the range of 0.10 to 0.30 grams per drink; and
h) water in the range of 11 to 12 fluid ounces per drink.

### Fourth Embodiment

A drinking fruit formulation having the following ingredients:
a) dried strawberry puree in the range of 15.0 to 18.0 grams per drink;
b) dried pure maple syrup in the range of 8.0 to 9.9 grams per drink;
c) cane sugar in the range of 3.0 to 7.0 grams per drink;
d) dried raspberry puree in the range of 3.0 to 6.0 grams per drink;
e) dried blueberry puree in the range of 3.0 to 5.0 grams per drink;
f) dried mixed berry natural flavoring in the range of 1.75 to 2.85 grams per drink;
g) dried beet juice in the range of 0.7 to 1.10 grams per drink;
h) dried acerola berry juice in the range of 0.10 to 0.30 grams per drink; and
i) water in the range of 11 to 12 fluid ounces per drink.

### Fifth Embodiment

A drinking fruit formulation having the following ingredients:
a) dried strawberry puree in the range of 18.0 to 21.0 grams per drink;
b) dried banana puree in the range of 7.50 to 9.25 grams per drink;
c) dried pure maple syrup in the range of 8.0 to 9.9 grams per drink;
d) cane sugar in the range of 3.0 to 7.0 grams per drink;
e) dried strawberry banana natural flavoring in the range of 1.0 to 2.25 grams per drink;
f) dried acerola berry juice in the range of 0.10 to 0.30 grams per drink; and
g) water in the range of 11 to 12 fluid ounces per drink.

### Sixth Embodiment

A drinking fruit formulation having the following ingredients:
a) dried blueberry puree in the range of 13.0 to 15.0 grams per drink;
b) dried strawberry puree in the range of 10.0 to 12.25 grams per drink;
c) dried pure maple syrup in the range of 8.0 to 9.9 grams per drink;
d) cane sugar in the range of 4.0 to 6.0 grams per drink;
e) dried cherry lemon natural flavoring in the range of 1.5 to 2.5 grams per drink;
f) dried acerola berry juice in the range of 0.10 to 0.30 grams per drink; and
g) water in the range of 11 to 12 fluid ounces per drink.

### Seventh Embodiment

A drinking vegetable formulation having the following ingredients:
a) dried sweet potato puree in the range of 10.0 to 17.25 grams per drink;
h) dried carrot juice in the range of 7.0 to 8.5 grams per drink;
c) dried pure maple syrup in the range of 7.2 to 8.25 grams per drink;
d) cane sugar in the range of 4.8 to 5.2 grains per drink;
e) dried natural peach mango flavoring in the range of 1.5 to 1.9 grams per drink;
f) dried spinach puree in the amount of 0.3 to 0.4 grams per drink;
g) dried spinach juice in the amount of 0.3 to 0.4 grams per drink;
h) dried beet juice in the amount of 0.6 to 0.725 grains per drink;
i) citric acid in the amount of 0.6 to 0.9 grams per drink;
j) dried acerola berry juice in the amount of 0.1 to 0.3 grams per drink; and
k) water in the range of 11 to 12 fluid ounces per drink.

### Eighth Embodiment

A drinking vegetable formulation having the following ingredients:
a) dried sweet potato puree in the range of 10.0 to 17.25 grams per drink;
b) dried carrot juice in the range of 7.0 to 8.5 grams per drink;
c) dried pure maple syrup in the range of 7.2 to 8.25 grams per drink;
d) cane sugar in the range of 4.8 to 5.2 grams per drink;
e) dried natural chocolate cherry flavoring in the range of 4.0 to 5.24 grams per drink;
f) dried spinach puree in the amount of 0.3 to 0.4 grams per drink;
g) dried spinach juice in the amount of 0.3 to 0.4 grams per drink;
h) dried beet juice in the amount of 0.6 to 0.725 grams per drink;
i) dried acerola berry juice in the amount of 0.1 to 0.3 grams per drink;
j) dried kale puree in the amount of 0.2 to 0.3 grams per drink;
k) dried kale juice in the amount of 0.2 to 0.3 grams per drink; and
l) water in the range of 11 to 12 fluid ounces per drink;

### Ninth Embodiment

A drinking vegetable formulation having the following ingredients:
a) dried sweet potato puree in the range of 10 to 17.25 grams per drink;
b) dried carrot juice in the range of 7.0 to 8.5 grams per drink;
c) dried pure maple syrup in the range of 7.20 to 8.25 grams per drink;
d) cane sugar in the range of 4.8 to 5.2 grams per drink;
e) dried natural creamy orange flavoring in the range of 2.50 to 3.04 grams per drink;
f) citric acid in the range of 0.6 to 0.9 gram per drink;
g) dried acerola berry juice in the range of 0.10 to 0.30 grams per drink; and
h) water in the range of 11 to 12 fluid ounces per drink.

### Tenth Embodiment

A drinking fruit formulation having the following ingredients:
a) dried strawberry puree in the range of 16.00 to 17.25 grams per drink;
b) dried pure maple syrup in the range of 8.75 to 9.75 grams per drink;
c) cane sugar in the range of 4.8 to 5.2 grams per drink;
d) dried raspberry puree in the range of 4.25 to 5.25 grams per drink;
e) dried blueberry puree in the range of 3.0 to 4.25 grams per drink;
f) dried mixed berry natural flavoring in the range of 2.0 to 3.25 grams per drink;
g) dried beet juice in the range of 0.80 to 0.95 grams per drink;
h) dried acerola berry juice in the amount of 0.1 to 0.3 grams per drink; and
i) water in the range of 11 to 12 fluid ounces per drink.

### Eleventh Embodiment

A drinking fruit formulation having the following ingredients:
a) dried strawberry puree in the range of 19.00 to 20.25 grams per drink;
b) dried banana puree in the range of 8.0 to 9.25 grams per drink;
c) dried pure maple syrup in the range of 8.75 to 9.75 grams per drink;
d) cane sugar in the range of 4.8 to 5.2 grams per drink;
e) dried strawberry banana natural flavoring in the range of 1.15 to 2.10 grams per drink;
f) dried acerola berry juice in the amount of 0.1 to 0.3 grams per drink; and
g) water in the range of 11 to 12 fluid ounces per drink.

### Twelfth Embodiment

A drinking fruit formulation having the following ingredients:
a) dried blueberry puree in the range of 13.75 to 14.8 grains per drink;
b) dried strawberry puree in the range of 10.5 to 11.75 grams per drink;
c) dried pure maple syrup in the range of 8.75 to 9.75 grams per drink;
d) cane sugar in the range of 4.8 to 5.2 grams per drink;
e) dried cherry lemon natural flavoring in the range of 1.60 to 2.3 grams per drink;
f) dried acerola berry juice in the amount of 0.1 to 0.3 grams per drink; and
g) water in the range of 11 to 12 fluid ounces per drink.

### Advantages of the Present Invention

It is an advantage of the present invention to provide a unique combination of ingredients and a unique combination of quantities of each ingredient, which provide optimum nutrition and optimum taste, using natural ingredients.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A drinking vegetable formulation having the following ingredients, comprising:
(a) dried sweet potato puree in the range of 9 to 17 grams per drink;
(b) dried carrot juice in the range of 6 to 10 grams per drink;
(c) dried pure maple syrup in the range of 5.60 to 9.60 grams per drink;
(d) cane sugar in the range of 3.00 to 7.00 grams per drink; and
(e) dried natural flavoring in the range of 1.50 to 2.25 grams per drink.

2. A drinking vegetable formulation in accordance with claim 1, further including dried spinach puree in the range of 0.2 to 0.5 grams per drink.

3. A drinking vegetable formulation in accordance with claim 1, further including dried spinach juice in the range of 0.2 to 0.5 grams per drink.

4. A drinking vegetable formulation in accordance with claim 1 further including dried beet juice in the range of 0.5 to 0.8 grams per drink.

5. A drinking vegetable formulation in accordance with claim 1, further including citric acid in the range of 0.5 to 1.0 gram per drink.

6. A drinking vegetable formulation in accordance with claim 1, further including dried acerola berry juice in the range of 0.10 to 0.30 grams per drink.

7. A drinking vegetable formulation in accordance with claim 1, further including water in the range of 11 to 12 fluid ounces per drink.

8. A drinking vegetable formulation in accordance with claim 1, further including dried kale puree in the range of 0.2 to 0.4 grams per drink.

9. A drinking vegetable formulation in accordance with claim 1, further including dried kale juice in the range of 0.2 to 0.4 grams per drink.

10. A drinking vegetable formulation in accordance with claim 1, further including dried peach mango natural flavoring in the range of 1.50 to 2.25 grams per drink.

11. A drinking vegetable formulation in accordance with claim 1, further including dried chocolate cherry natural flavoring in the range of 3.75 to 6.25 grams per drink.

12. A drinking vegetable formulation in accordance with claim 1, further including dried creamy orange natural flavoring in the range of 2.50 to 3.25 grams per drink.

13. A drinking fruit formulation having the following ingredients, comprising:
(a) dried strawberry puree in the range of 15.0 to 18.0 grams per drink;
(b) dried pure maple syrup in the range of 8.0 to 9.9 grams per drink;
(c) cane sugar in the range of 3.0 to 7.0 grams per drink;
(d) dried raspberry puree in the range of 3.0 to 6.0 grams per drink;
(e) dried blueberry puree in the range of 3.0 to 5.0 grams per drink; and
(f) dried mixed berry natural flavoring in the range of 1.75 to 2.85 grains per drink.

14. A drinking fruit formulation in accordance with claim 13, further including dried beet juice in the range of 0.7 to 1.10 grams per drink.

15. A drinking fruit formulation in accordance with claim 13, further including dried acerola berry juice in the range of 0.10 to 0.30 grams per drink.

16. A drinking fruit formulation in accordance with claim 13, further including water in the range of 11 to 12 fluid ounces per drink.

17. A drinking fruit formulation having the following ingredients, comprising:
(a) dried strawberry puree in the range of 18.0 to 21.0 grams per drink;
(h) dried banana puree in the range of 7.50 to 9.25 grams per drink;
(c) dried pure maple syrup in the range of 8.0 to 9.9 grams per drink;
(d) cane sugar in the range of 3.0 to 7.0 grams per drink; and
(e) dried strawberry banana natural flavoring in the range of 1.0 to 2.25 grams per drink.

18. A drinking fruit formulation in accordance with claim 17, further including dried acerola berry juice in the range of 0.10 to 0.30 grams per drink.

19. A drinking fruit formulation in accordance with claim 17, further including water in the range of 11 to 12 fluid ounces per drink.

20. A drinking fruit formulation having the following ingredients, comprising:
(a) dried blueberry puree in the range of 13.0 to 15.0 grams per drink;
(b) dried strawberry puree in the range of 10.0 to 12.25 grams per drink;
(c) dried pure maple syrup in the range of 8.0 to 9.9 grams per drink;
(d) cane sugar in the range of 4.0 to 6.0 grams per drink; and
(e) dried cherry lemon natural flavoring in the range of 1.5 to 2.5 grams per drink.

21. A drinking fruit formulation in accordance with claim 20, further including dried acerola berry juice in the range of 0.10 to 0.30 grams per drink.

22. A drinking fruit formulation in accordance with claim 20, further including water in the range of 11 to 12 fluid ounces per drink.

23. A drinking vegetable formulation having the following ingredients, comprising:
(a) dried sweet potato puree in the range of 10.0 to 17.25 grams per drink;
(b) dried carrot juice in the range of 7.0 to 8.5 grams per drink;
(c) dried pure maple syrup in the range of 7.2 to 8.25 grams per drink;
(d) cane sugar in the range of 4.8 to 5.2 grams per drink; and
(e) dried natural flavoring in the range of 1.50 to 5.0 grams per drink.

24. A drinking vegetable formulation in accordance with claim 23, further including dried spinach puree in the amount of 0.3 to 0.4 grams per drink.

25. A drinking vegetable formulation in accordance with claim 23, further including dried spinach juice in the amount of 0.3 to 0.4 grams per drink.

26. A drinking vegetable formulation in accordance with claim 23, further including dried beet juice in the amount of 0.6 to 0.725 grains per drink.

27. A drinking vegetable formulation in accordance with claim 23, further including citric acid in the amount of 0.6 to 0.9 grams per drink.

28. A drinking vegetable formulation in accordance with claim 23, further including dried acerola berry juice in the amount of 0.1 to 0.3 grams per drink.

29. A drinking vegetable formulation in accordance with claim 23, further including water in the range of 11 to 12 fluid ounces per drink.

30. A drinking vegetable formulation in accordance with claim 23, further including dried kale puree in the amount of 0.2 to 0.3 grams per drink.

31. A drinking vegetable formulation in accordance with claim 23, further including dried kale juice in the amount of 0.2 to 0.3 grams per drink.

32. A drinking vegetable formulation in accordance with claim 23, further including dried peach mango natural flavoring in the range of 1.50 to 1.90 grams per drink.

33. A drinking vegetable formulation in accordance with claim 23, further including dried chocolate cherry natural flavoring in the range of 4.0 to 5.24 grams per drink.

34. A drinking vegetable formulation in accordance with claim 23, further including dried creamy orange natural flavoring in the range of 2.5 to 3.04 grams per drink.

35. A drinking fruit formulation having the following ingredients, comprising:
(a) dried strawberry puree in the range of 16.00 to 17.25 grams per drink;
(b) dried pure maple syrup in the range of 8.75 to 9.75 grams per drink;
(c) cane sugar in the range of 4.8 to 5.2 grams per drink;
(d) dried raspberry puree in the range of 4.25 to 5.25 grams per drink;
(e) dried blueberry puree in the range of 3.0 to 4.25 grams per drink; and
(f) dried mixed berry natural flavoring in the range of 2.0 to 3.25 grams per drink.

36. A drinking fruit formulation in accordance with claim 35, further including dried beet juice in the range of 0.80 to 0.95 grams per drink.

37. A drinking fruit formulation in accordance with claim 35, further including dried acerola berry juice in the amount of 0.1 to 0.3 grams per drink.

38. A drinking fruit formulation in accordance with claim 13, further including water in the range of 11 to 12 fluid ounces per drink.

39. A drinking fruit formulation having the following ingredients, comprising:
(a) dried strawberry puree in the range of 19.00 to 20.25 grams per drink;
(b) dried banana puree in the range of 8.0 to 9.25 grams per drink;
(c) dried pure maple syrup in the range of 8.75 to 9.75 grams per drink;
(d) cane sugar in the range of 4.8 to 5.2 grams per drink; and
(c) dried strawberry banana natural flavoring in the range of 1.15 to 2.10 grams per drink.

40. A drinking fruit formulation in accordance with claim 39, further including dried acerola berry juice in the amount of 0.1 to 0.3 grams per drink.

41. A drinking fruit formulation in accordance with claim 39, further including water in the range of 11 to 12 fluid ounces per drink.

42. A drinking fruit formulation having the following ingredients, comprising:
(a) dried blueberry puree in the range of 13.75 to 14.8 grams per drink;
(b) dried strawberry puree in the range of 10.5 to 11.75 grams per drink;
(c) dried pure maple syrup in the range of 8.75 to 9.75 grams per drink;
(d) cane sugar in the range of 4.8 to 5.2 grams per drink; and
(e) dried cherry lemon natural flavoring in the range of 1.60 to 2.3 grams per drink.

43. A drinking fruit formulation in accordance with claim 42, further including dried acerola berry juice in the amount of 0.1 to 0.3 grams per drink.

44. A drinking fruit formulation in accordance with claim 42, further including water in the range of 11 to 12 fluid ounces per drink.
